(19) United States
(12) Patent Application Publication
(10) Pub. No.: US 2008/0140854 A1
(43) Pub. Date: Jun. 12, 2008

(54) METHOD AND APPARATUS FOR STREAMING AV DATA

(75) Inventors: Seung-woo SHIN, Yongin-si (KR); Hyo-sun Shim, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/870,541

(22) Filed: Oct. 11, 2007

(30) Foreign Application Priority Data
Dec. 7, 2006 (KR) 2006-124048

(51) Int. Cl. G06F 15/16

(52) U.S. Cl. 709/231

(57) ABSTRACT

A method of and apparatus for streaming audio/video (A/V) data. The method of streaming AV data from a server to a client includes receiving information on a reception environment of AV data from the client while streaming the AV data to the client, and changing an error correction method applied to at least one of video data and audio data in the AV data based on the received information. In this way, when a reception environment gets worse, the client can normally reproduce at least audio data, and thus quality of service (QoS), which a user reproducing the AV data recognizes, improves.

### CROSS-REFERENCE TO RELATED APPLICATION

This application claims the benefit of Korean Application No. 2006-124048, filed on Dec. 7, 2006 in the Korean Intellectual Property Office, the disclosure of which is incorporated herein by reference.

### BACKGROUND OF THE INVENTION

1. Field of the Invention

Aspects of the present invention relate to a method and apparatus to stream audio/video (A/V) data, and more particularly, to a method and apparatus to efficiently guarantee quality of service (QoS) of a streaming service even under deterioration of a reception environment of AV data.

2. Description of the Related Art

FIG. 1 is a diagram illustrating an apparatus to stream an audio/video (AV) data stream and an apparatus to receive the AV data stream according to the related art. Referring to FIG. 1, in a conventional streaming environment, a server encodes audio data and video data separately. First, audio data is encoded in an audio encoding unit 11 according to a predetermined compression method. Unnecessary information is removed and data is compressed, thereby reducing the amount of data to be transmitted and enabling efficient data transmission.

After the encoding of the audio data is finished, an audio error correction encoding unit 12 performs channel coding of the compressed audio data. Channel coding is a method of adding redundancy data to original data so that a client can detect or correct an error occurring in a channel during transmission of the audio data.

In the same manner as that of the audio data, video data is also encoded in a video encoding unit according to a predetermined compression method in order to compress video data. After the encoding of the video data is finished, a video error correction encoding unit 14 performs error correction encoding.

The error correction encoded audio data and video data are multiplexed and transmitted to a client in the form of a data stream. The client receiving the data stream demultiplexes the data stream. Through the demultiplexing, the data stream is separated into audio data and video data. Then, in an audio error correction unit 15 and a video error correction unit 17, error corrections according to predetermined methods are respectively performed for the separate audio data and video data, and the original audio data and the original video data are restored in an audio decoding unit 16 and a video decoding unit 18, respectively.

According to FIG. 1, the server performs error correction encoding of the audio data and video data according to a predetermined error correction encoding method without consideration of a reception environment of a data stream, and transmits the encoded data. Accordingly, if the reception environment of the stream deteriorates and the client becomes unable to perform error correction, neither the audio data nor the video data can be reproduced. In particular, when a network transmitting a stream is a wireless communication network, such as a wireless local area network (WLAN), it is highly probable that the quality of the reception environment of a stream may rapidly deteriorate. However, if a user can continuously receive at least one of audio data and video data, the quality of service (QoS) which the user recognizes can be maintained or improved despite deterioration of the reception environment.

In AV data, the size of audio data is relatively small compared to the size of corresponding video data. For example, in the case of a digital versatile disk (DVD) video having a total capacity of 4.7 GB, 3.4 GB are used to record video data and 1.3 GB are used to record audio and other data. Since the size of the audio data is smaller than that of the video data, the probability that original audio data can be restored by performing error correction despite deterioration of a reception environment is higher than that of the video data. Accordingly, if this asymmetry in the sizes of the audio data and the corresponding video data is used, the QoS experienced by the user can be maintained or improved.

### SUMMARY OF THE INVENTION

Aspects of the present invention provide a method and apparatus to maintain a service quality of streaming AV data by changing an error correction method applied to at least one of audio data and video data according to a reception environment of a stream. Aspects of the present invention also provide a computer readable recording medium having embodied thereon a computer program to execute the method.

According to an aspect of the present invention, a method for a server to stream audio/video (AV) data from the server to a client includes receiving information on a reception environment of AV data from the client while the server streams the AV data to the client, and changing an error correction method applied to at least one of video data and audio data in the AV data based on the received information.

According to an aspect the changing of the error correction method includes determining whether the FEC method applied to the audio data in the AV data should be changed based on the received information, and selectively changing a forward error correction (FEC) method applied to the audio data according to the determination result.

According to an aspect, the changing of the FEC method includes changing a size of redundancy data added to the audio data in the AV data.

According to another aspect of the present invention, a method of enabling a client to receive an AV data stream from a server includes transmitting information on a reception environment of AV data to the server while receiving a first AV data stream from the server, and receiving a second AV data stream which is streamed by the server after changing an error correction method applied to at least one of video data and audio data in the AV data, wherein the changing of the error correction method is based on the transmitted information.

According to another aspect, the transmitting of the information on the reception environment of the AV data includes transmitting an RTCP packet or an RTSP packet including the information on the reception environment of the AV data to the server.

According to another aspect, the AV data is Internet protocol television (IPTV) content data.

According to another aspect of the present invention, an apparatus to stream AV data from a server to a client includes an information reception unit to receive information on a reception environment of AV data from the client while the server streams the AV data to the client, and a control unit to change an error correction method applied to at least one of video data and audio data of the AV data based on the received information.

According to another aspect, the control unit includes a determination unit to determine whether the error correction method applied to the audio data in the AV data should be changed based on the received information, and a changing unit to selectively change the FEC method applied to the audio data according to the determination result.

According to another aspect of the present invention, an apparatus which is included in a client to receive an AV data stream from a server includes an information transmission unit to transmit information on a reception environment of AV data to the server while receiving the AV data streamed from the server, and a stream reception unit to receive the AV data which is streamed by the server after an error correction method applied to at least one of video data and audio data in the AV data has been changed based on the transmitted information.

According to another aspect of the present invention, there is provided a computer readable recording medium having embodied thereon a computer program to execute the method of streaming and receiving AV data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an apparatus to stream an audio/video (AV) data stream and an apparatus to receive an AV data stream according to conventional technology;

FIG. 2 is a flowchart illustrating a method of streaming AV data according to an embodiment of the present invention;

FIG. 3 is a flowchart illustrating a method of correcting an error of AV data according to an embodiment of the present invention;

FIG. 4 is a diagram illustrating an apparatus to stream AV data according to an embodiment of the present invention;

FIG. 5 is a diagram illustrating an apparatus to stream AV data according to another embodiment of the present invention; and

FIG. 6 is a diagram illustrating an apparatus to receive AV data according to an embodiment of the present invention.

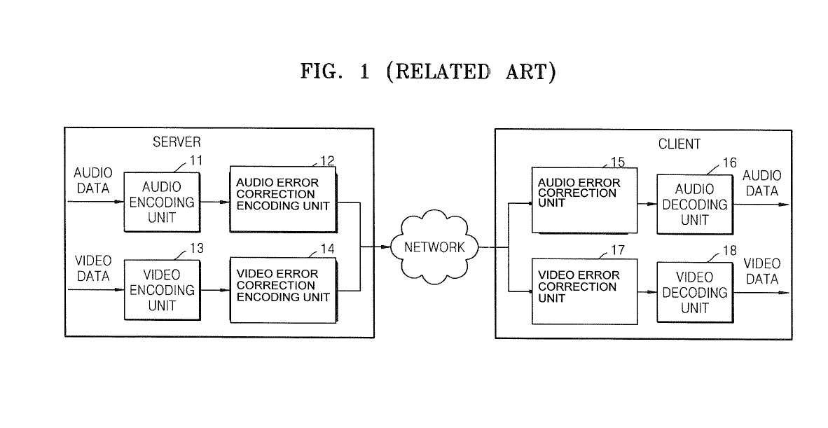

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

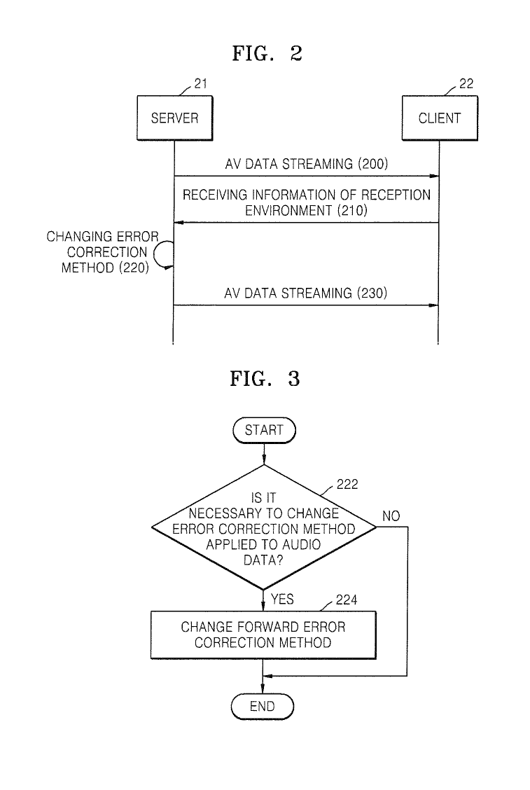

FIG. 2 is a flowchart illustrating a method of streaming audio/video (AV) data according to an embodiment of the present invention. Referring to FIG. 2, a server 21 streams AV data to a client 22. The server 21 may be an Internet protocol television (IPTV) server and the client 22 may be an IPTV client. Also, the server 21 may stream AV data to the client 22 through an IP network. However, it is understood that the server 21 is not limited to being an IPTV server, the client 22 is not limited to being an IPTV client, and the AV data is not limited to being streamed through an IP network.

In operation 200, the server 21 streams the AV data to the client 22. In operation 210, the client 22 transmits information on the reception environment of the AV data to the server 21. Specifically, while receiving the AV data stream from the server 21 through a wired and/or wireless network, the client 22 transmits information on the reception environment to the server 21. The information on the reception environment includes various types of information related to network congestion. For example, the information in the reception environment may include information on packet loss, jitter, data stream delays, and the like.

At least one of a real-time transport control protocol (RTCP) and a real-time streaming protocol (RTSP) packet is transmitted to the server 21. The RTCP or RTSP enables the client 22 to transmit information on packet loss, jitter, and the like to the server 21. Thus, according to these protocols, information on the reception environment can be transmitted to the server 21. The information on the reception environment may be periodically transmitted to the server 21, may be transmitted when a change occurs in the reception environment, or may be transmitted according to some other conditions.

In operation 220, the server 21 changes an error correction method applied to at least one of the video data and the audio data of the AV data being streamed to the client 22, based on the information transmitted by the client in operation 210.

In the stream transmitted by the server 21 to the client 22, the size of the video data is greater than the size of the corresponding audio data. Accordingly, when the reception environment of the data stream deteriorates, the probability of loss of the video data is higher than that of the corresponding audio data. Therefore, when the reception environment of the data stream deteriorates, an error correction method applied to the video data should be changed to a more robust method such that the more robust method can be applied to correct errors in the video data. For example, when a forward error correction (FEC) method is used to correct errors in the video data, if errors are detected, additional redundancy data can be added to the video data before additional video data is transmitted to the client 22.

However, if the reception environment deteriorates beyond a certain point, even if the error correction method applied to the video data is changed, the client 22 becomes unable to perform error correction. For example, even if more redundancy data is added to the video data in order to perform FEC before the additional video data is streamed, the client may not be able to restore the original video data. In addition, since the size of the video data is bigger than that of the audio data, the amount of redundancy data applied to the video data is also bigger than the amount of redundancy data applied to the audio data. Accordingly, in a limited bandwidth, redundancy data cannot be added to the video data beyond a certain limit.

Meanwhile, since the size of the audio data is small, the probability of loss of the audio data is lower than that of the video data. Also, the amount of redundancy data which should be added to audio data for FEC is less than the amount which should be added to the video data for FEC. Thus, according to another aspect of the present invention, when a reception environment deteriorates to the extent that the client 22 cannot sufficiently restore video data, only an error correction method applied to the audio data is changed. For example, after adding more redundancy data to the audio data for FEC, the audio data can be transmitted. Therefore, the client 22 can restore and reproduces at least the original audio data, thereby improving the quality of service (QoS) which a user experiences.

Also, according to another aspect of the present invention, since the bandwidth used to stream data is limited, the size of redundancy data added to the video data may be reduced and more redundancy data may be correspondingly added to the audio data, in order to normally reproduce the audio data. It is understood that the proportions of redundancy data added to the audio data and video data can be varied according to the bandwidth and other conditions as well.

In operation 230, the server 21 streams the AV data to which the changed error correction method has been applied to the client 22.

FIG. 3 is a flowchart illustrating an embodiment of the method of changing an error correction method used to correct errors in AV data shown in FIG. 2. FIG. 3 illustrates operation 220 performed by the server 21 in FIG. 2, in more detail. Referring to FIG. 3, in operation 222, it is determined whether or not the error correction method applied to the audio data should be changed based on the information on the reception environment of the data stream transmitted by the client 22 in operation 210.

According to an aspect of the present invention, since only the error correction method applied to the audio data is changed, it is determined in operation 222 whether the error correction method applied to the audio data should be changed. However, according to other aspects, it can be determined whether the error correction methods applied to both the audio and video data should be changed, or whether only the error correction method applied to the video data should be changed. Operation 222 is performed by referring to information on packet loss, jitter, and the like included in an RTCP or RTSP packet. If it is determined in operation 222 that the error correction method should not be changed, AV data is continuously streamed in the same manner as in operation 200.

If it is determined in operation 222 that the error correction method should be changed, the FEC method of the audio data is changed in operation 224. Specifically, to change the FEC method, more redundancy data may be added to the audio data such that the client 22 can normally restore at least the audio data.

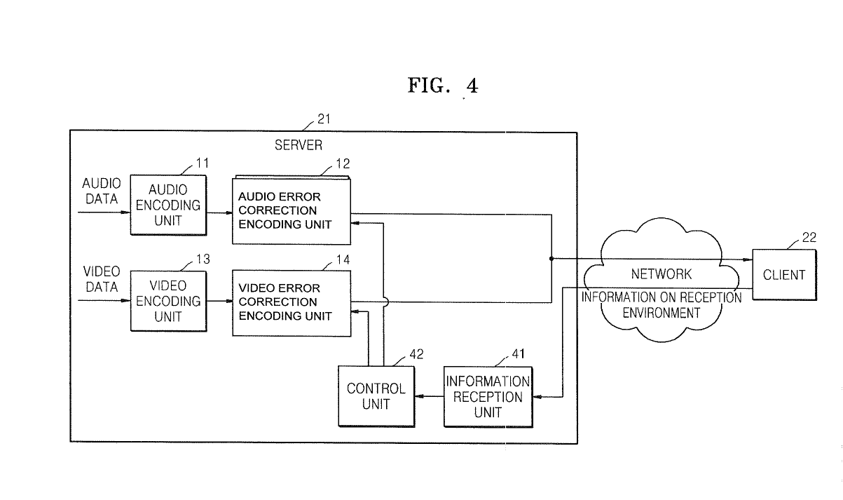

FIG. 4 is a diagram illustrating an apparatus to stream AV data according to an embodiment of the present invention. Referring to FIG. 4, the streaming apparatus of the server 21 includes an information reception unit 41 and a control unit 42. It is understood that the client 22 illustrated in FIG. 4 may include components such as display units, speaker units, input units, and various other types of components commonly used with devices which receive data streams over a network.

The information reception unit 41 receives information on the reception environment of an AV data stream transmitted from a client 22. The information on the reception environment includes various types of information related to network congestion, such as, for example, information on packet loss, jitter, delay, and the like. The information on the reception environment reflects the QoS experienced by the user.

The client 22 transmits the information on the reception environment in the form of an RTCP or an RTSP packet. Then, the information reception unit 41 receives the transmitted information on the reception environment from the client 22. Based on the information on the reception environment received by the information reception unit 41, the control unit 42 changes an error correction method applied to at least one of the video data and the audio data. For example, if the information on the reception environment indicates that the QoS has dropped below a certain predetermined QoS level, the control unit 42 changes an error correction method applied to at least one of the video data and the audio data.

When many errors occur in the video data, the control unit 42 changes the error correction method applied to the video data to a more robust method than the method originally applied. The control unit 42 may further change the error correction method applied to the audio data to a more robust method so that the client 22 can normally restore at least the audio data. By increasing or decreasing the size of redundancy data added during the application of the FEC method, the error correction method is changed.

Also, according to an aspect of the present invention, since the bandwidth used to stream AV data is limited, the control unit 42 may reduce the size of redundancy data to be added to the video data in order to add more redundancy data to the audio data.

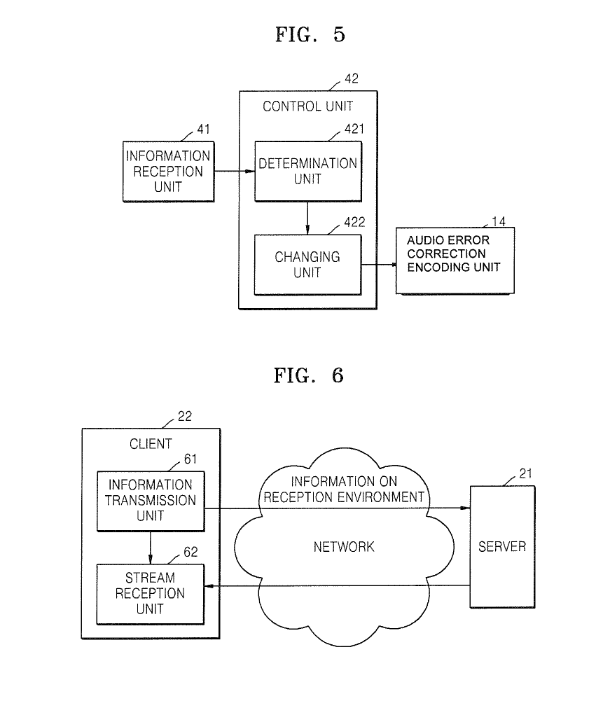

FIG. 5 is a diagram illustrating the control unit 42 shown in FIG. 4, according to an aspect of the present invention. Referring to FIG. 5, the control unit 42 includes a determination unit 421 and a changing unit 422.

The determination unit 421 determines whether the error correction method applied to the audio data should be changed based on the information on the reception environment of the data stream transmitted from the information reception unit 41. According to an aspect of the present invention, since only the error correction method applied to the audio data is changed, the determination unit 421 determines only whether the error correction method applied to the audio data should be changed. However, it is understood that the determination unit 421 can also determine whether the error correction methods applied to both the audio data and the video data should be changed, and whether the error correction method applied to only the video data should be changed.

When information on the reception environment is included in an RTCP or RTSP packet and then transmitted to the determination unit 421, it is determined whether the error correction method applied to the audio data should be changed by referring to information on packet loss, jitter, and the like, included in the RTCP or RTSP packet. However, it is understood that the information on the reception environment is not required to be included in an RTCP or RTSP packet, and may instead be included in other known types of packets.

The changing unit 422 selectively changes the error correction method applied to the audio data according to the determination result of the determination unit 421. By controlling the audio error correction encoding unit 12 which performs error correction encoding of audio data, the changing unit 422 changes the error correction method applied to the audio data. For FEC, the error correction method is changed by increasing or decreasing the size of redundancy data added to the audio data.

FIG. 6 is a diagram illustrating an apparatus to receive AV data according to an embodiment of the present invention. Referring to FIG. 6, the apparatus to receive an AV data stream of a client 22 includes an information transmission unit 61 and a stream reception unit 62.

The information transmission unit 61 transmits information on a reception environment while receiving a first AV data stream transmitted from the server 21. The information on the reception environment may be included in an RTCP or an RTSP packet and then transmitted to the server 21. The information on the reception environment may be transmitted periodically, may be transmitted only when a change occurs in the reception environment, or may be transmitted according to some other conditions.

The stream reception unit 62 receives a second AV data stream which the server streams after an error correction method applied to at least one of the video data and the audio data is selectively changed, based on the information on the reception environment transmitted by the information transmission unit 61. After increasing or decreasing the size of redundancy data added to the audio data for FEC, the transmitted AV data stream is streamed and received by the stream reception unit 62. The received AV data stream is demultiplexed into audio data and video data, and through error correction and decoding, the audio data and the video data are restored to the original audio data and video data.

According to aspects of the present invention, an error correction method applied to at least one of video data and audio data can be selectively changed, and thus, QoS can be improved with respect to a reception environment. Even when a reception environment deteriorates to the point where the video data cannot be reproduced, audio data can still be normally reproduced, and thus QoS, which a user reproducing the AV data recognizes, improves.

Aspects of the present invention can also be embodied as computer readable codes on a computer readable recording medium. For example, the control unit 42 can be embodied as a computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in this is defined in the claims and their equivalents.

1. A method for a server to stream audio/video (AV) data from the server to a client, the method comprising:
receiving information on a reception environment of AV data from the client while the server streams the AV data to the client; and
changing an error correction method applied to at least one of video data and audio data in the AV data based on the received information.

2. The method of claim 2, wherein the error correction method initially applied to the AV data comprises a forward error correction (FEC) method.

3. The method of claim 2, wherein the changing of the error correction method comprises:
determining whether the FEC method applied to the audio data in the AV data should be changed based on the received information; and
selectively changing the (FEC) method applied to the audio data according to the determination result.

4. The method of claim 3, wherein the changing of the FEC method comprises changing a size of redundancy data added to the audio data in the AV data.

5. The method of claim 1, wherein the receiving of the information on the reception environment comprises receiving a real-time control protocol (RTCP) packet or a real-time streaming protocol (RTSP) packet, each of which includes the information on the reception environment.

6. The method of claim 1, wherein the AV data comprises Internet protocol television (IPTV) content data.

7. The method of claim 1, wherein the information on the reception environment of the AV data comprises information related to at least one of packet loss, jitter, and delay.

8. The method of claim 4, wherein the changing of the size of the redundancy data comprises increasing the size of the redundancy data so that the audio data can be normally restored by the client.

9. A method of enabling a client to receive an AV data stream from a server, the method comprising:
transmitting information on a reception environment of AV data to the server while receiving a first AV data stream from the server; and
receiving a second AV data stream which is streamed by the server after selectively changing an error correction method applied to at least one of video data and audio data in the second AV data stream, wherein the selective changing of the error correction method is based on the transmitted information.

10. The method of claim 9, wherein the selective changing of the second AV data stream comprises changing a size of redundancy data added to the audio data of the AV data.

11. The method of claim 9, wherein the transmitting of the information on the reception environment of the AV data comprises transmitting an RTCP packet or an RTSP packet, each of which includes the information on the reception environment of the AV data, to the server.

12. The method of claim 9, wherein the AV data comprises Internet protocol television (IPTV) content data.

13. The method of claim 9, wherein the information on the reception environment of the AV data comprises information related to at least one of packet loss, jitter, and delay.

14. An apparatus to stream AV data from a server to a client, the apparatus comprising:
an information reception unit to receive information on a reception environment of AV data transmitted from the client while the server streams the AV data to the client; and
a control unit to change an error correction method applied to at least one of video data and audio data in the AV data based on the received information.

15. The apparatus of claim 14, wherein the control unit comprises:
a determination unit to determine whether the error correction method applied to the audio data in the AV data should be changed based on the received information; and
a changing unit to selectively change an FEC method applied to the audio data according to the determination result.

16. The apparatus of claim 15, wherein the changing unit changes a size of redundancy data added to the audio data in the AV data.

17. The apparatus of claim 14, wherein the information reception unit receives the information on the reception environment of the AV data by receiving an RTCP packet or an RTSP packet, each of which includes the information on the reception environment of the AV data.

18. The apparatus of claim 14, wherein the AV data comprises Internet protocol television (IPTV) content data.

19. The apparatus of claim 14, wherein the information on the reception environment of the AV data comprises information related to at least one of packet loss, jitter, and delay.

20. The apparatus of claim 16, wherein the changing of the size of the redundancy data comprises increasing the size of the redundancy data so that the audio data can be normally restored by the client.

21. An apparatus which is included in a client to receive an AV data stream from a server, the apparatus comprising:
an information transmission unit to transmit information on a reception environment of AV data to the server while receiving the AV data streamed from the server; and
a stream reception unit to receive the AV data which is streamed by the server after an error correction method applied to at least one of video data and audio data in the AV data has been changed based on the transmitted information.

22-51. (canceled)
